(19) United States
(12) Patent Application Publication
(10) Pub. No.: US 2025/0251291 A1
(43) Pub. Date: Aug. 7, 2025

(54) TEMPERATURE ACQUISITION CIRCUIT, METHOD, AND DEVICE, STORAGE MEDIUM, AND CHARGING AND POWER DISTRIBUTION SYSTEM ASSEMBLY

(71) Applicant: SAIC GM Wuling Automobile Co., Ltd., Liuzhou (CN)

(72) Inventors: Xiaobin ZHAO, Liuzhou (CN); Shanxuan HUANG, Liuzhou (CN); Bin LI, Liuzhou (CN); Min WEI, Liuzhou (CN); Xuejun WEI, Liuzhou (CN); Jinjiang CHEN, Liuzhou (CN)

(73) Assignee: SAIC GM Wuling Automobile Co., Ltd., Liuzhou (CN)

(21) Appl. No.: 19/191,203

(22) Filed: Apr. 28, 2025

Related U.S. Application Data
(63) Continuation of application No. PCT/CN2024/142996, filed on Dec. 27, 2024.

(30) Foreign Application Priority Data
Dec. 29, 2023 (CN) 202311864406.X

(51) Int. Cl. G01K 7/24; G01K 7/42; H02J 7/00

(52) U.S. Cl. CPC G01K 7/24; G01K 7/42; H02J 7/00309; H02J 7/0047

(57) ABSTRACT

Embodiments of the present disclosure provide an acquisition temperature circuit, method, and device, a storage medium, and a charging and power distribution system assembly. The acquisition temperature circuit includes a main control board and a power board provided with a first thermistor, a second thermistor, and an optocoupler isolation circuit. The first thermistor is connected to the optocoupler isolation circuit, the optocoupler isolation circuit is connected to the main control board, and the second thermistor is connected to the main control board. In the technical solutions provided by the embodiments of the present disclosure, two thermistors are provided on the power board of the charging and power distribution system assembly, avoiding temperature measurement errors caused by over-range of the thermistor located on the power board, improving the accuracy of temperature acquisition of the charging and power distribution system assembly, and thus improving the charging safety of the power battery.

### CROSS-REFERENCE TO RELATED APPLICATIONS

The present application is a bypass continuation application of International Patent Application No. PCT/CN2024/142996, filed on Dec. 27, 2024, which claims priority to Chinese Patent Application No. 202311864406.X, filed on Dec. 29, 2023, the contents of which are incorporated herein by reference in their entireties.

### TECHNICAL FIELD

The present disclosure relates to the field of vehicle technologies, and in particular to a temperature acquisition circuit, method, and device, a storage medium, and a charging and power distribution system assembly.

### BACKGROUND

The circuit board of the charging and power distribution system assembly on the vehicle includes at least a main control chip, and the main control chip can collect temperature signals in the charging and power distribution system assembly. The traditional acquisition method is generally to convert the voltage value of the thermistor on the acquisition board into an on-board temperature value through analog-to-digital conversion, thereby determining the temperature of the charging and power distribution system assembly during operation. However, in the design process of the circuit board of the charging and power distribution system assembly, a distance between the thermistor and the sampling pin of the main control chip is sometimes too long due to the fact that the thermistor sometimes has to avoid other electronic components, resulting in errors in the temperature signal acquired by the main control chip, affecting the control of the charging and power distribution system assembly, which may cause the charging time to be extended, pose a safety hazard, and have an adverse effect on the power battery.

### SUMMARY

In view of this, embodiments of the present disclosure provide a temperature acquisition circuit, method, and device, a storage medium, and a charging and power distribution system assembly to improve the accuracy of temperature acquisition of the charging and power distribution system assembly, thereby improving the charging safety of the power battery.

In a first aspect, embodiments of the present disclosure provide a temperature acquisition circuit which includes a main control board and a power board. The power board is provided with a first thermistor, a second thermistor, and an optocoupler isolation circuit. The first thermistor is connected to the optocoupler isolation circuit, the optocoupler isolation circuit is connected to the main control board, and the second thermistor is connected to the main control board.

In some embodiments, the power board is further provided with a hysteresis comparator, an integrator, and a follower, and the hysteresis comparator, the integrator, and the follower jointly form a triangular wave generator.

In some embodiments, the power board is provided with an operational amplifier, and the operational amplifier is connected to the triangular wave generator and is also connected to the first thermistor.

In a second aspect, embodiments of the present disclosure provide a temperature acquisition method, which is applied to the above temperature acquisition circuit. The temperature acquisition method includes: obtaining a first temperature of the first thermistor and a second temperature of the second thermistor; and determining, based on the first temperature and the second temperature, an acquisition temperature of a charging and power distribution system assembly.

In some embodiments, before acquiring the first temperature of the first thermistor and the second temperature of the second thermistor, the method includes obtaining a pulse width modulated wave signal. The pulse width modulated wave signal is obtained based on a triangular wave signal voltage of the triangular wave generator and the first voltage of the first thermistor, and the pulse width modulated wave signal is used to indicate the first temperature.

In some embodiments, the determining, based on the first temperature and the second temperature, the acquisition temperature of the charging and power distribution system assembly, includes: when the first temperature is greater than or equal to a first preset threshold and the second temperature is smaller than a second preset threshold, taking the second temperature as the acquisition temperature of the charging and power distribution system assembly; or when the first temperature is greater than or equal to the first preset threshold and the second temperature is greater than or equal to a third preset threshold, taking the first temperature as the acquisition temperature of the charging and power distribution system assembly; or when the first temperature is greater than or equal to the first preset threshold and the second temperature is greater than or equal to the second preset threshold and smaller than the third preset threshold, taking the first temperature as the acquisition temperature of the charging and power distribution system assembly; or when the first temperature is smaller than the first preset threshold, taking the first temperature as the acquisition temperature of the charging and power distribution system assembly.

In some embodiments, the first preset threshold includes 125 degrees Celsius, the second preset threshold includes −40 degrees Celsius, and the third preset threshold includes 25 degrees Celsius.

In a third aspect, embodiments of the present disclosure provide a temperature acquisition device including a first acquisition module and a determination module. The first acquisition module is configured to acquire a first temperature of a first thermistor and a second temperature of a second thermistor, and the determination module is configured to determine an acquisition temperature of a charging and power distribution system assembly based on the first temperature and the second temperature.

In a fourth aspect, embodiments of the present disclosure provide a storage medium including programs stored on the storage medium. When the programs are running, a device where the storage medium is located is controlled to execute the above temperature acquisition method.

In a fifth aspect, embodiments of the present disclosure provide a charging and power distribution system assembly, including a memory and a processor. The memory is configured to store information including program instructions, the processor is configured to control execution of the program instructions, and the program instructions are loaded and executed by the processor to implement steps of the above temperature acquisition method.

In the technical solutions of the temperature acquisition circuit provided by the embodiments of the present disclosure, the temperature acquisition circuit includes the main control board and the power board, the power board is provided with a first thermistor, a second thermistor, and an optocoupler isolation circuit, the first thermistor is connected to the optocoupler isolation circuit, the optocoupler isolation circuit is connected to the main control board, and the second thermistor is connected to the main control board. In the technical solutions provided by the embodiments of the present disclosure, two thermistors are provided on the power board of the charging and power distribution system assembly, avoiding temperature measurement errors caused by over-range of the thermistor located on the power board, improving the accuracy of temperature acquisition of the charging and power distribution system assembly, and thus improving the charging safety of the power battery.

### BRIEF DESCRIPTION OF DRAWINGS

In order to more clearly illustrate the embodiments of the present disclosure, the accompanying drawings used in the embodiments are briefly described below. The drawings described below are merely a part of the embodiments of the present disclosure. For ordinary technicians in this field, without creative efforts, other drawings can be obtained based on these drawings.

FIG. 1 is a schematic diagram of a temperature acquisition circuit provided by some embodiments of the present disclosure.

FIG. 2 is a schematic diagram of a power board provided by some embodiments of the present disclosure.

FIG. 3 is a flow chart of a temperature acquisition method provided by some embodiments of the present disclosure.

FIG. 4 is a schematic diagram of obtaining a pulse width modulated wave signal provided by some embodiments of the present disclosure.

FIG. 5 is a waveform schematic diagram of a triangular wave signal voltage and a first voltage provided by some embodiments of the present disclosure.

FIG. 6 is a schematic diagram of a relationship between a resistance value and a temperature of a thermistor provided by some embodiments of the present disclosure.

FIG. 7 is a schematic diagram of a temperature acquisition device provided by some embodiments of the present disclosure; and

FIG. 8 is a schematic diagram of a charging and power distribution system assembly provided by embodiments of the present disclosure.

### DESCRIPTION OF EMBODIMENTS

In order to understand the technical solutions of the present disclosure, the embodiments of the present disclosure are described in details with reference to the drawings.

It should be clear that the described embodiments are merely a part of the embodiments of the present disclosure rather than all of the embodiments. Based on the embodiments of the present disclosure, all other embodiments obtained by ordinary technicians in this field without creative efforts shall fall within the protection scope of the present disclosure.

The terms used in the embodiments of the present disclosure are only for the purpose of describing specific embodiments and are not intended to limit the present disclosure. The singular forms of “a/an”, “the” and “said” used in the embodiments of the present disclosure and the appended claims are also intended to include the plural forms, unless the context clearly indicates other meanings.

It should be understood that the term “and/or” used in this article is only a description of the association relationship of the associated objects, indicating that there may be three relationships. For example, A and/or B can indicate: A alone, A and B, and B alone. In addition, the character “/” in this article generally indicates that the associated objects are in an “or” relationship.

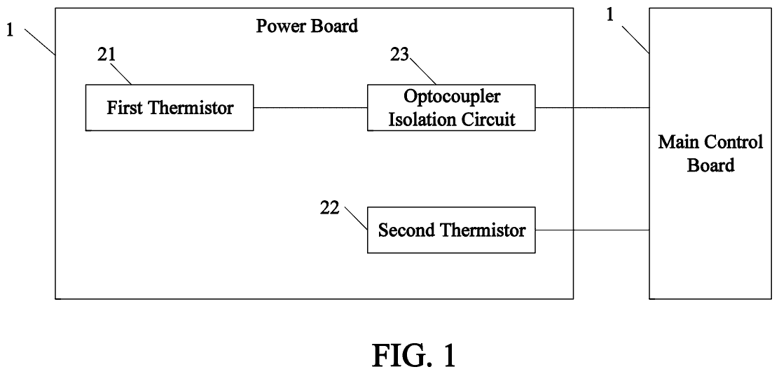

FIG. 1 is a schematic diagram of a temperature acquisition circuit provided by some embodiments of the present disclosure. As shown in FIG. 1, the temperature acquisition circuit includes a main control board 1 and a power board 2. The power board 2 is provided with a first thermistor 21, a second thermistor 22, and an optocoupler isolation circuit 23. The first thermistor 21 is connected to the optocoupler isolation circuit 23, the optocoupler isolation circuit 23 is connected to the main control board 1, and the second thermistor 22 is connected to the main control board 1.

In some embodiments, a core part of the optocoupler isolation circuit 23 is an optocoupler device including a light-emitting diode (LED) and a phototransistor (optoelectronic transistor).

In some embodiments, a hysteresis comparator 24, an integrator 25, and a follower 26 are also provided on the power board 2, and the hysteresis comparator 24, the integrator 25, and the follower 26 jointly form a triangular wave generator.

In some embodiments, an output of the operational amplifier 27 is connected to an inverting input terminal of the integrator 25 for integration, and an output of the integrator 25 is connected to a non-inverting input terminal of the hysteresis comparator 24 to control the conversion of high and low levels of the hysteresis comparator 24. The triangular wave generator can generate a triangular wave of 200 Hz.

In some embodiments, an operational amplifier 27 is also provided on the power board 2, and the operational amplifier 27 is connected to the triangular wave generator, and the operational amplifier 27 is connected to the first thermistor 21.

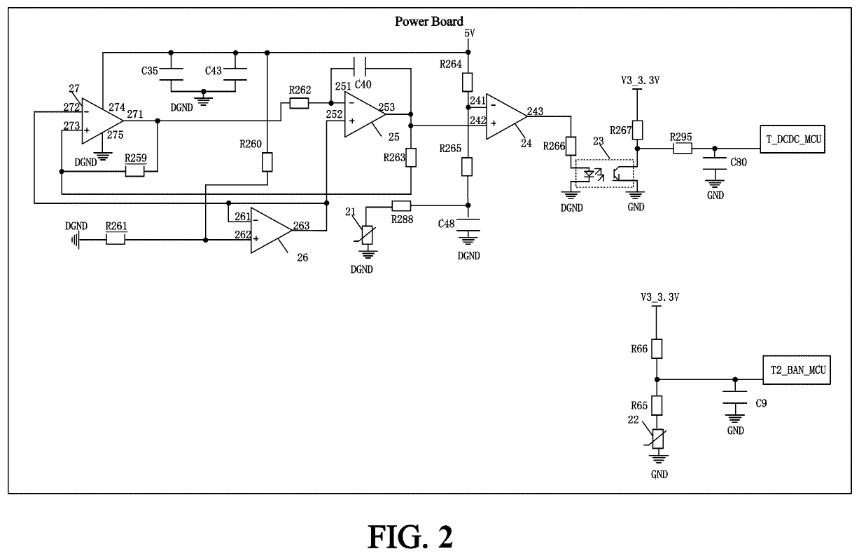

FIG. 2 is a circuit diagram of a power board provided by some embodiments of the present disclosure. As shown in FIG. 2, an operational amplifier 27 includes 5 pins, a first pin 272 of the operational amplifier 27 is connected to a first pin 261 of a follower 26, a third pin 263 of the follower 26, and a second pin 252 of an integrator 25. A second pin 273 of the operational amplifier 27 is connected to a resistor R259 and a resistor R263. A third pin 271 of the operational amplifier 27 is connected to a resistor R259 and a resistor R262. A fourth pin 274 of the operational amplifier 27 is connected to a capacitor C35, a capacitor C43, a resistor R260, and a resistor R264. The other terminal of the capacitor C35 and the other terminal of the capacitor C43 are grounded to DGND. A fifth pin 275 of the operational amplifier 27 is grounded to DGND. A second pin 262 of the follower 26 is connected to a resistor R261 and a resistor R260, and the other terminal of the resistor R261 is grounded to DGND. A first pin 251 of the integrator 25 is connected to a resistor R262 and a capacitor C40. The third pin 253 of the integrator 25 is connected to the capacitor C40, the second pin 242 of the hysteresis comparator 24, and the resistor R263. The first pin 241 of the hysteresis comparator 24 is connected to the resistor R264 and the resistor R265. The resistor R265 is connected to the capacitor C48 and the resistor R288. The other terminal of the capacitor C48 is grounded to DGND. The resistor R288 is connected to the first thermistor 21, and the other terminal of the first thermistor 21 is grounded to DGND. The third pin 243 of the hysteresis comparator 24 is connected to the resistor R266. The resistor R266 is grounded to DGND through the optocoupler isolation circuit 23. The resistor R267 is grounded to GND through the optocoupler isolation circuit 23. The resistor R267 is connected to the resistor R295, and the resistor R295 is connected to the capacitor C80, and the other terminal of the capacitor C80 is grounded to GND. The resistor R295 is connected to the first output T_DCDC_MCU.

The resistor R66 is connected to the resistor R65, the capacitor C9, and the second output T2_BAN_MCU, and the other terminal of capacitor C9 is grounded to GND. The resistor R65 is connected to second thermistor 22, and the other terminal of the second thermistor 22 is grounded to GND. The first output T_DCDC_MCU and the second output T2_BAN_MCU can be connected to the main control board 1.

In the technical solutions provided by the embodiments of the present disclosure, the temperature acquisition circuit includes a main control board and a power board, the power board is provided with a first thermistor, a second thermistor and an optocoupler isolation circuit, the first thermistor is connected to the optocoupler isolation circuit, the optocoupler isolation circuit is connected to the main control board, and the second thermistor is connected to the main control board. In the technical solutions provided by the embodiments of the present disclosure, two thermistors are provided on the power board of the charging and power distribution system assembly, avoiding temperature measurement errors caused by over-range of the thermistor located on the power board, improving the accuracy of temperature acquisition of the charging and power distribution system assembly, and thus improving the charging safety of the power battery.

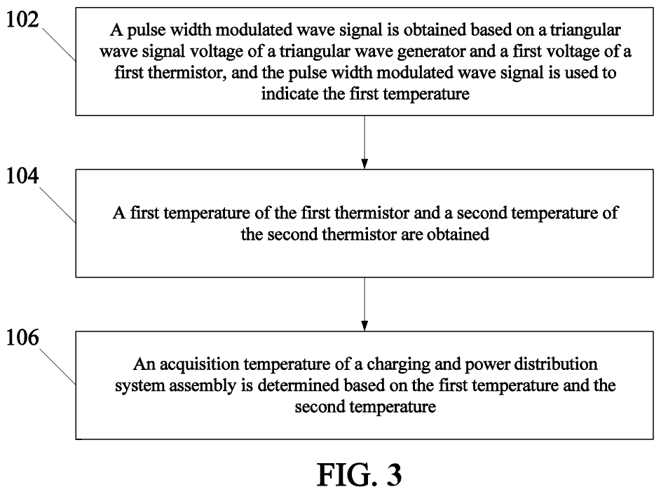

Based on the temperature acquisition circuit in FIG. 1, some embodiments of the present disclosure provide a temperature acquisition method. FIG. 3 is a flow chart of a temperature acquisition method provided by some embodiments of the present disclosure. As shown in FIG. 3, the method includes the following steps.

At step 102, a pulse width modulated wave signal is obtained. The pulse width modulated wave signal is obtained according to the triangular wave signal voltage of the triangular wave generator and the first voltage of the first thermistor, and the pulse width modulated wave signal is used to indicate the first temperature.

In some embodiments, each step can be executed by the main control board of the charging and power distribution system assembly. For example, the main control board includes a microcontroller unit (MCU).

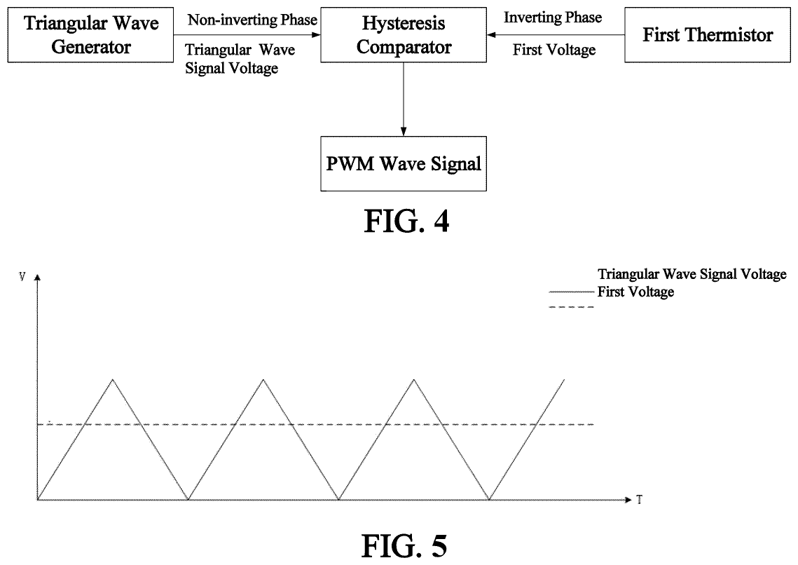

FIG. 4 is a schematic diagram of obtaining a pulse width modulated wave signal provided by some embodiments of the present disclosure. As shown in FIG. 4, the triangular wave of 200 Hz generated by the triangular wave generator can be used as a non-inverting input signal of the hysteresis comparator, and the first voltage of the first thermistor can be used as an inverting input signal of the hysteresis comparator. Since the resistance signal of the first thermistor changes with the temperature, when the temperature of the power board decreases, the resistance value of the first thermistor increases, and when the temperature of the power board increases, the resistance value of the thermistor decreases. Therefore, the voltage at the inverting input terminal of the hysteresis comparator is a voltage that changes with the temperature. When the voltage of the triangular wave signal is higher than the first voltage of the first thermistor, the hysteresis comparator outputs a high voltage. When the voltage of the triangular wave signal is lower than the first voltage of the first thermistor, the hysteresis comparator outputs a low voltage. When the voltage of the triangular wave signal is equal to the first voltage of the first thermistor, the hysteresis comparator outputs the voltage at the previous moment. So far, a pulse width modulated (PWM) wave signal of 200 Hz with a duty cycle that changes with temperature can be obtained. The PWM wave signal is configured to feedback the temperature on the power board of the charging and power distribution system assembly.

FIG. 5 is a waveform diagram of a triangular wave signal voltage and a first voltage provided by some embodiments of the present disclosure. As shown in FIG. 5, the ordinate in FIG. 5 indicates the voltage, the abscissa indicates the time, the solid line in FIG. 5 represents the triangular wave signal voltage, and the dotted line represents the first voltage.

In some embodiments, an optocoupler isolation circuit can be configured to transmit the PWM wave signal on the power board to the PWM pin of the main control board to serve as a temperature judgment signal.

At step 104, the first temperature of the first thermistor and the second temperature of the second thermistor are obtained.

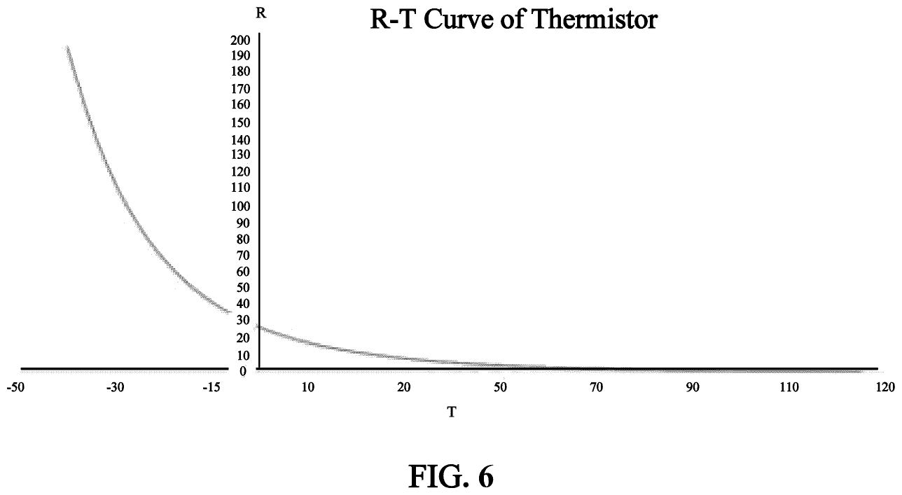

In some embodiments, the first thermistor is a thermistor provided on the power board, because the resistance signal of the thermistor changes with the change of temperature, when the temperature decreases, the resistance value of the thermistor increases, and when the temperature increases, the resistance value of the thermistor decreases. Therefore, the resistance value of the first thermistor can be calculated according to its first voltage, and then the resistance value reflects the temperature on the power board based on the relationship between the resistance and temperature of the thermistor as shown in FIG. 6. The voltage of the first thermistor is the first voltage.

FIG. 6 is a schematic diagram of a relationship between a resistance value and a temperature of a thermistor provided by some embodiments of the present disclosure. As shown in FIG. 6, the abscissa in FIG. 6 is the temperature of the thermistor in degrees Celsius, and the ordinate in FIG. 6 is the resistance value of the thermistor in ohms. The resistance value of the thermistor decreases as its temperature increases.

In order to avoid temperature measurement errors caused by over-range of the thermistor located on the power board, the power board is further provided with a second thermistor. The second thermistor is arranged at a position of the power board close to an inter-board connector to avoid a long-line transmission. The second thermistor has a same working principle as the first thermistor, and the second thermistor can reflect an on-board temperature through its voltage value. The voltage of the second thermistor is the second voltage, and the second temperature corresponding to the second voltage is an on-board temperature of the charging and power distribution system assembly.

At step 106, the acquisition temperature of the charging and power distribution system assembly is determined based on the first temperature and the second temperature.

In some embodiments, when the first temperature is greater than or equal to a first preset threshold and the second temperature is smaller than a second preset threshold, the second temperature is taken as the acquisition temperature of the charging and power distribution system assembly; or when the first temperature is greater than or equal to the first preset threshold and the second temperature is greater than or equal to a third preset threshold, the first temperature is taken as the acquisition temperature of the charging and power distribution system assembly; or when the first temperature is greater than or equal to the first preset threshold, and the second temperature is greater than or equal to the second preset threshold and smaller than the third preset threshold, the first temperature is taken as the acquisition temperature of the charging and power distribution system assembly; or when the first temperature is smaller than the first preset threshold, the first temperature is taken as the acquisition temperature of the charging and power distribution system assembly.

In some embodiments, the first preset threshold, the second preset threshold, and the third preset threshold can be set according to actual conditions. Optionally, the first preset threshold is 125 degrees Celsius, the second preset threshold is −40 degrees Celsius, and the third preset threshold is 25 degrees Celsius.

In some embodiments, when the ambient temperature is −40 degrees Celsius, the resistance value of the first thermistor 21 is 195.652K by looking up a table, and a voltage of the first pin 241 of the hysteresis comparator 24 can be calculated to be 4.87V by resistor voltage division, and, compared with the highest voltage 5V of the pulse signal of the second pin 242 of the hysteresis comparator 24, the third pin 243 of the hysteresis comparator 24 should output a PWM wave signal with a duty cycle of 2.5%. However, due to the small duty cycle and errors, the third pin 243 of the hysteresis comparator 24 will output a low level, resulting in that T_DCDC_MCU actually collected by the MCU is a high level. In this case, the temperature should be 125 degrees Celsius through circuit conversion, which is inconsistent with the actual −40 degrees Celsius. Therefore, a second thermistor 22 is provided on the power board, and when the sampling temperature of the PWM wave signal is greater than or equal to 125 degrees, and the sampling temperature of the second thermistor 22 is smaller than or equal to −40 degrees Celsius, the ambient temperature is low at this time, and the acquisition temperature of the charging and power distribution system assembly can be based on the on-board temperature (second temperature). When the sampling temperature of the PWM wave signal is greater than or equal to 125 degrees Celsius, and the sampling temperature of the second thermistor 22 is greater than or equal to 25 degrees Celsius, the ambient temperature is high at this time, and the acquisition temperature of the charging and power distribution system assembly can be based on the first temperature corresponding to the PWM wave signal. When the sampling temperature of the PWM wave signal is smaller than 125 degrees Celsius, the acquisition temperature of the charging and power distribution system assembly can be based on the first temperature corresponding to the PWM wave signal.

In the technical solutions provided by the embodiments of the present disclosure, the temperature acquisition circuit includes a main control board and a power board, the power board is provided with a first thermistor, a second thermistor and an optocoupler isolation circuit, the first thermistor is connected to the optocoupler isolation circuit, the optocoupler isolation circuit is connected to the main control board, and the second thermistor is connected to the main control board. In the technical solutions provided by the embodiments of the present disclosure, two thermistors are provided on the power board of the charging and power distribution system assembly, avoiding temperature measurement errors caused by over-range of the thermistor located on the power board, improving the accuracy of temperature acquisition of the charging and power distribution system assembly, and thus improving the charging safety of the power battery.

In the technical solutions provided by the embodiments of the present disclosure, the temperature on the power board of the charging and power distribution system assembly is collected by using multiple electronic components, and the first temperature is compared with the second temperature, thereby improving the temperature acquisition accuracy.

In the technical solutions provided by the embodiments of the present disclosure, a redundant design is used, and two thermistors are provided on the power board of the charging and power distribution system assembly, avoiding temperature measurement errors caused by over-range of the thermistor located on the power board, thus ensuring the validity of the temperature signal.

In the technical solutions provided by the embodiments of the present disclosure, a method for obtaining a PWM wave signal is provided, which can quickly and accurately feedback the temperature of the power board, which not only provides a reference for judging the acquisition temperature of the entire charging and power distribution system assembly, but also provides technical guidance for subsequent temperature acquisition in other systems within the vehicle.

In the technical solutions provided by the embodiments of the present disclosure, in the process of acquiring the temperature of the power board, a PWM wave signal of 200 Hz with a duty cycle that changes with temperature can be obtained by inputting high voltage and low voltage under different conditions through the operational amplifier, without using too many components, eliminating the influence of line resistance on the collection accuracy.

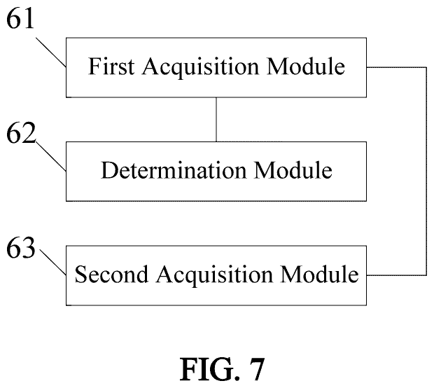

Embodiments of the present disclosure provides an acquisition temperature device. FIG. 7 is a schematic diagram of an acquisition temperature device provided by some embodiments of the present disclosure. As shown in FIG. 7, the device includes a first acquisition module 61 and a determination module 62.

The first acquisition module 61 is configured to obtain a first temperature of a first thermistor and a second temperature of a second thermistor.

The determination module 62 is configured to determine an acquisition temperature of a charging and power distribution system assembly according to the first temperature and the second temperature.

In some embodiments, the device further includes a second acquisition module 63.

The second acquisition module 63 is configured to obtain a pulse width modulated wave signal according to a triangular wave signal voltage of a triangular wave generator and a first voltage of a first thermistor, and the pulse width modulated wave signal is used to indicate the first temperature.

In some embodiments, the second acquisition module 62 is configured to: take the second temperature as the acquisition temperature of the charging and power distribution system assembly when the first temperature is greater than or equal to a first preset threshold and the second temperature is smaller than a second preset threshold, or take the first temperature as the acquisition temperature of the charging and power distribution system assembly when the first temperature is greater than or equal to the first preset threshold and the second temperature is greater than or equal to a third preset threshold, or take the first temperature as the acquisition temperature of the charging and power distribution system assembly when the first temperature is greater than or equal to the first preset threshold, and the second temperature is greater than or equal to the second preset threshold and smaller than the third preset threshold, or take the first temperature as the acquisition temperature of the charging and power distribution system assembly when the first temperature is smaller than the first preset threshold.

In some embodiments, the first preset threshold includes 125 degrees Celsius, the second preset threshold includes −40 degrees Celsius, and the third preset threshold includes 25 degrees Celsius.

In the technical solutions provided by the embodiments of the present disclosure, the acquisition temperature circuit includes the main control board and the power board, the power board is provided with a first thermistor, a second thermistor, and an optocoupler isolation circuit, first thermistor is connected to the optocoupler isolation circuit, the optocoupler isolation circuit is connected to the main control board, and the second thermistor is connected to the main control board. In the technical solutions provided by the embodiments of the present disclosure, two thermistors are provided on the power board of the charging and power distribution system assembly, avoiding temperature measurement errors caused by over-range of the thermistor located on the power board, improving the accuracy of temperature acquisition of the charging and power distribution system assembly, and thus improving the charging safety of the power battery.

The acquisition temperature device provided by the embodiments can be configured to implement the above acquisition temperature method in FIG. 3. Specific description can be referred to the embodiments of the above acquisition temperature method, which will not be repeated herein.

The embodiments of the present disclosure provides a storage medium, the storage medium includes programs stored on the storage medium. When the programs are running, the device where the storage medium is located is controlled to execute each step in the embodiments of the above acquisition temperature method. Specific description can be referred to the embodiments of the above acquisition temperature method.

Some embodiments of the present disclosure provide a charging and power distribution system assembly including a memory and a processor, the memory is configured to store information including program instructions, the processor is configured to control the execution of the program instructions, and the program instructions are loaded and executed by the processor to implement steps in the embodiments of the above acquisition temperature method. Specific description can be referred to the embodiments of the above temperature acquisition method.

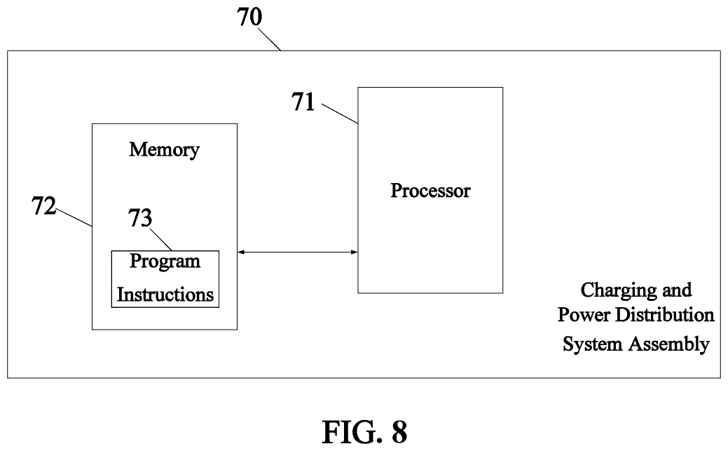

FIG. 8 is a schematic diagram of a charging and power distribution system assembly provided by some embodiments of the present disclosure. As shown in FIG. 8, the charging and power distribution system assembly 70 of the embodiments includes a processor 71, a memory 72, and a computer program 73 stored on the memory 72 and executable by the processor 71. When the computer program 73 is executed by the processor 71, the acquisition temperature method in the embodiments is performed, which will not be repeated herein to avoid repetition. Optionally, when the computer program is executed by the processor 71, the functions of each module/unit in the acquisition temperature device in the embodiments are implemented, which will not be repeated herein to avoid repetition.

The charging and power distribution system assembly 70 includes, but is not limited to, a processor 71 and a memory 72. Those skilled in the art can understand that FIG. 8 is only an example of the charging and power distribution system assembly 70, and does not limit the charging and power distribution system assembly 70. The charging and power distribution system assembly 70 can include more or fewer components than the structure shown in the drawings, or combine certain components, or different components. For example, the charging and power distribution system assembly can also include input and output devices, network access devices, buses, etc.

The processor 71 can be a central processing unit (CPU), or other general processors, a digital signal processors (DSP), an application specific integrated circuit (ASIC), a field-programmable gate array (FPGA), or other programmable logic device, a discrete gate or a transistor logic device, a discrete hardware component, etc. The general processor can be a microprocessor or the processor can also be any conventional processor, etc.

The memory 72 can be an internal storage unit of the charging and power distribution system assembly 70, such as a hard disk or memory of the charging and power distribution system assembly 70. The memory 72 may also be an external storage device of the charging and power distribution system assembly 70, such as a plug-in hard disk, a smart media card (SMC), a secure digital (SD) card, a flash card and so on, which are equipped on the charging and power distribution system assembly 70. In some embodiments, the memory 72 may also include both an internal storage unit of the charging and power distribution system assembly 70 and an external storage device. The memory 72 is configured to store computer programs and other programs and data required by the charging and power distribution system assembly. The memory 72 may also be configured to temporarily store data that has been output or is to be output.

Those skilled in the art can clearly understand that, for the convenience and simplicity of description, the specific working process of the above system, device, and unit can refer to the corresponding process in the aforementioned method embodiments, which will not be repeated herein.

In the several embodiments provided by the present disclosure, it should be understood that the disclosed system, device, and method can be implemented in other ways. For example, the device embodiments described above are only schematic. For another example, the division of the units is only a logical function division, and there may be other division methods in actual implementation. For another example, multiple units or components can be combined or integrated into another system, or some features can be ignored or not executed. Another point is that the coupling or direct coupling or communication connection between each other shown or discussed can be through some interfaces, indirect coupling or communication connection of devices or units, which can be electrical, mechanical or other forms.

The units described as separate components may or may not be physically separated, and the components shown as units may or may not be physical units, that is, they may be located in one place, or they may be distributed on multiple network units. Some or all of the units can be selected according to actual needs to achieve the purpose of the scheme of the embodiments.

In addition, each functional unit in each embodiments of the present disclosure can be integrated into a processing unit, or each unit can exist physically separately, or two or more units can be integrated into one unit. The above integrated unit can be implemented in the form of hardware or in the form of hardware plus software functional units.

The above integrated unit implemented in the form of software functional units can be stored in a computer readable storage medium. The above software functional unit is stored on a storage medium including several instructions so that a computer device (which may be a personal computer, a server, or a network device, etc.) or a processor can execute some steps of the method described in each embodiment of the present disclosure. The aforementioned storage medium includes a U disk, a mobile hard disk, a read-only memory (ROM), a random access memory (RAM), a disk or optical disk and other media that can store program code.

The above description refers to some embodiments of the present disclosure and is not intended to limit the present disclosure. Any modification, equivalent replacement, improvement, etc., which are made within the principle of the present disclosure, shall fall within the protection scope of the present disclosure.

What is claimed is:

1. A temperature acquisition circuit, comprising:
a main control board; and
a power board provided with a first thermistor, a second thermistor, and an optocoupler isolation circuit, wherein the first thermistor is connected to the optocoupler isolation circuit, the optocoupler isolation circuit is connected to the main control board, and the second thermistor is connected to the main control board.

2. The circuit according to claim 1, wherein the power board is further provided with a hysteresis comparator, an integrator, and a follower, wherein the hysteresis comparator, the integrator, and the follower jointly form a triangular wave generator.

3. The circuit according to claim 2, wherein the power board is further provided with an operational amplifier, the operational amplifier is connected to the triangular wave generator, and the operational amplifier is connected to the first thermistor.

4. A temperature acquisition method, applied to a temperature acquisition circuit, wherein the temperature acquisition circuit comprises a main control board and a power board provided with a first thermistor, a second thermistor, and an optocoupler isolation circuit, wherein the first thermistor is connected to the optocoupler isolation circuit, the optocoupler isolation circuit is connected to the main control board, and the second thermistor is connected to the main control board, and
wherein the method comprises:
obtaining a first temperature of the first thermistor and a second temperature of the second thermistor; and
determining, based on the first temperature and the second temperature, an acquisition temperature of a charging and power distribution system assembly.

5. The method according to claim 4, wherein the power board is further provided with a hysteresis comparator, an integrator, and a follower, wherein the hysteresis comparator, the integrator, and the follower jointly form a triangular wave generator, and
wherein prior to obtaining the first temperature of the first thermistor and the second temperature of the second thermistor, the method further comprises:
obtaining a pulse width modulated wave signal based on a triangular wave signal voltage of the triangular wave generator and a first voltage of the first thermistor, wherein the pulse width modulated wave signal is used to indicate the first temperature.

6. The method according to claim 4, wherein said determining, based on the first temperature and the second temperature, the acquisition temperature of the charging and power distribution system assembly, comprises:
in response to the first temperature being greater than or equal to a first preset threshold and the second temperature being smaller than a second preset threshold, taking the second temperature as the acquisition temperature of the charging and power distribution system assembly; or
in response to the first temperature being greater than or equal to the first preset threshold and the second temperature being greater than or equal to a third preset threshold, taking the first temperature as the acquisition temperature of the charging and power distribution system assembly; or
in response to the first temperature being greater than or equal to the first preset threshold, and the second temperature being greater than or equal to the second preset threshold and smaller than the third preset threshold, taking the first temperature as the acquisition temperature of the charging and power distribution system assembly; or
in response to the first temperature being smaller than the first preset threshold, taking the first temperature as the acquisition temperature of the charging and power distribution system assembly.

7. The method according to claim 6, wherein the first preset threshold value comprises 125 degrees Celsius, the second preset threshold value comprises −40 degrees Celsius, and the third preset threshold value comprises 25 degrees Celsius.

8. A storage medium, applied to a temperature acquisition circuit, wherein the temperature acquisition circuit comprises a main control board and a power board provided with a first thermistor, a second thermistor, and an optocoupler isolation circuit, wherein the first thermistor is connected to the optocoupler isolation circuit, the optocoupler isolation circuit is connected to the main control board, and the second thermistor is connected to the main control board, and
wherein the storage medium comprising programs stored on the storage medium, wherein when the programs are running, a device where the storage medium is located is controlled to execute a temperature acquisition method, and the method comprises:
obtaining a first temperature of the first thermistor and a second temperature of the second thermistor; and
determining, based on the first temperature and the second temperature, an acquisition temperature of a charging and power distribution system assembly.
